(19) United States
(12) Patent Application Publication
(10) Pub. No.: US 2016/0088971 A1
(43) Pub. Date: Mar. 31, 2016

(54) PROTECTION AGAINST OVERCOOKING

(71) Applicant: Fredrlk LAGERLÖF, Stenkullen (SE)

(72) Inventor: Fredrik LAGERLOF, Stenkullen (SE)

(21) Appl. No.: 14/785,859

(22) PCT Filed: Apr. 23, 2014
(86) PCT No.: PCT/SE2014/050486

§ 371 Date: Oct. 21, 2015

(30) Foreign Application Priority Data
Apr. 23, 2013 (SE) 1330040-5

(51) Int. Cl. A47J 27/56; A47J 36/12

(52) U.S. Cl. CPC A47J 27/56; A47J 36/12

(57) ABSTRACT

An arrangement for preventing overcooking in a combination of cooking utensils with a lid includes an opening mechanism, arranged at the lid, for the regulated manoeuvring of an opening part thereon, which cooperates with an opening in the lid when temperatures close to the boiling point are reached in the cooking utensil. The opening mechanism includes a thermostat with a regulating piston of the type that has a built-in expanding body acting on the piston, the volume of which body is a function of the temperature in the environment of the thermostat. The thermostat is arranged, when temperatures approach the boiling point, to tend to cause the opening mechanism to guide the opening part into an open position in a regulated manner by the regulating piston. A spring is arranged, working against the thermostat to bias the opening mechanism and the opening part to a closed position at the opening.

The present invention relates to an arrangement for preventing overcooking with cooking utensils with a lid, in particular stew pans and the like for preparing food.

It is not unusual when preparing food that a stew pan provided with a lid and with liquid contents suddenly boils over, especially at the beginning of the procedure before the hot plate has been adjusted to the correct power, perhaps when it was turned to the maximum for a rapid start. The consequences of overcooking are, as everyone knows, a cleaning process that is not always simple, and often a film of burnt remnants remains on the hot plate that requires special cleaning agents and tools for their removal. In addition, cooking gases and an unpleasant odour spread through the area in spite of suction removal units being present. Therefore, overcooking should be avoided.

A manner of avoiding overcooking as far as possible is to continuously and personally monitor the stew pan, or stew pans if there are several, and then also continuously regulate the power of the hot plate/hot plates; however, there are very often other duties that require attention and one's presence. And, as everyone knows, the boiling point for milk is always reached when one is looking away.

Due to the above-cited predicament there are known arrangements that are provided to prevent overcooking of the type described above. The Swedish Patent Office referred in a commissioned search to four patents, WO 2006/091013, CN2310521, JP3055015 and CN201088470. In these publications there is a mechanism in all the arrangements described that uses a section of memory metal for regulating the opening/closing or the size of an opening for allowing pressure to escape from a cooking utensil. Memory metal sections have the great disadvantage that they have a hysteresis concerning the mechanical movement as a function of the temperature, and this hysteresis brings it about that the regulating of the opening becomes much too slow or does not occur at all in the case of small temperature changes. It is precisely at the boiling point that small temperature changes have a great effect on the liquid in the cooking utensil and since mechanisms with memory metal regulate poorly, the protection against overcooking also becomes poor with these mechanisms.

The above-cited problems in the known technology are avoided by the present invention. An arrangement in accordance with the invention has to this end an opening mechanism, arranged at the lid, for the regulated manoeuvring of an opening part on the lid, which opening part cooperates with an opening in the lid when temperatures close to the boiling point are reached in the cooking utensil, and which opening mechanism comprises a thermostat with a regulating piston and of the type that has a built-in expanding body acting on the piston and whose volume is a function of the temperature in the environment of the thermostat, whereby the thermostat is arranged, when temperatures approach the boiling point of the liquid in the cooking utensil, usually water, to tend to cause the opening mechanism to guide the opening part into an open position in a regulated manner by the regulating piston, and comprises a spring that is arranged to tend, working against the thermostat, to bias the opening mechanism and the opening part to a closed position at the opening when the temperature decreases. The opening is regulated in accordance with the progression of the cooking, and the regulation takes place with a hysteresis that is negligible in this connection.

In an embodiment of the arrangement in accordance with the invention the opening mechanism comprises a lever fastened in an articulated manner for opening the opening part. The lever is arranged so as to cooperate with the thermostat. A mechanism of this type is advantageous in that a lever length ratio change of the thermostat's movement can be achieved for a good regulation of the course of the opening.

In another embodiment of the invention the lever is arranged so as to cooperate with a manoeuvring surface on the opening part and comprises a first step part with two end contact points that alternatively cooperate with the manoeuvring surface. This brings about a changing in two steps in the lever length ratio that is advantageous if liquids are being boiled, where it is necessary to have a rapid further opening in an already open position.

In another, simpler embodiment of the invention the thermostat is arranged so as to mechanically operate directly against the spring with the opening part displaceably mounted between the thermostat and the spring.

The invention will be described and explained in the following in conjunction with a pair of exemplary embodiments shown in the attached drawings, in which

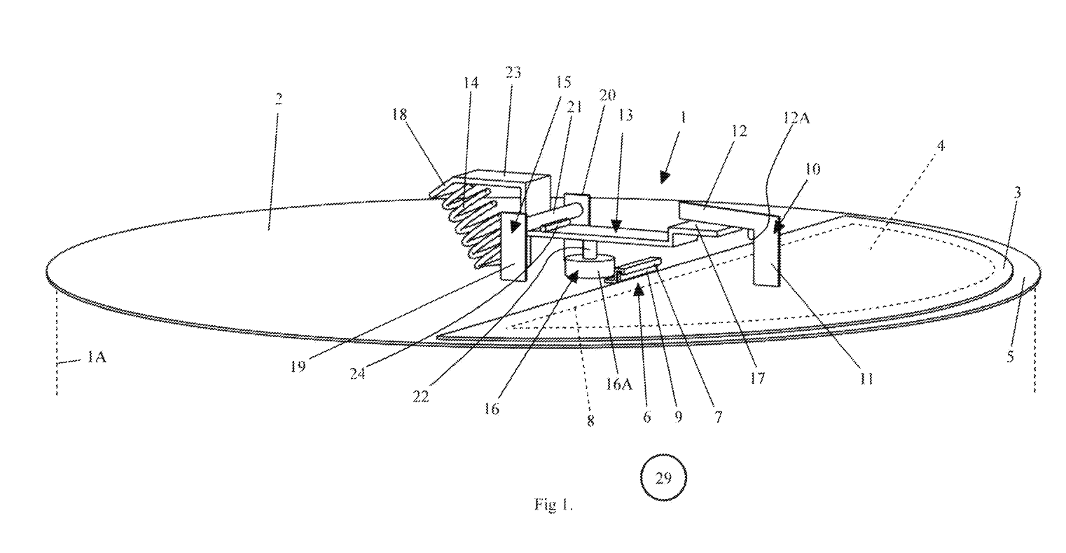

FIG. 1 schematically shows a perspective view of a stew pan with a first example of an arrangement in accordance with the invention,

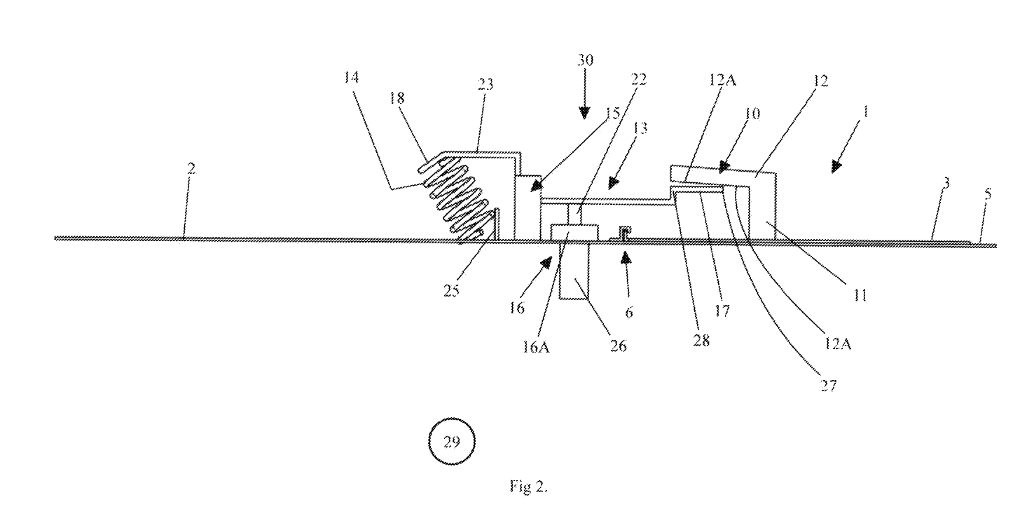

FIG. 2 shows a view of a stew pan lid according to FIG. 1 from the one side,

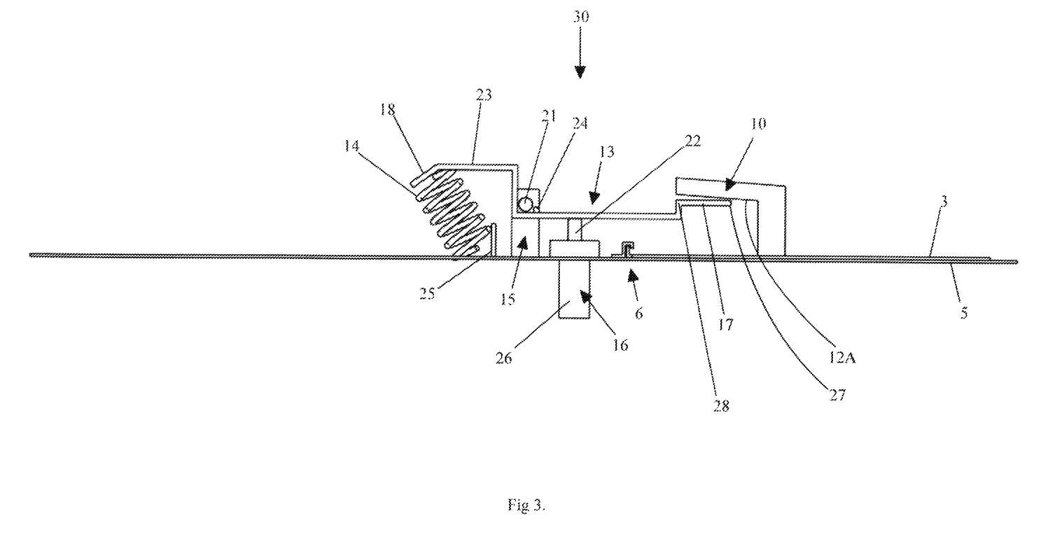

FIG. 3 shows a section through the stew pan lid according to FIG. 1 from the same side as in FIG. 2,

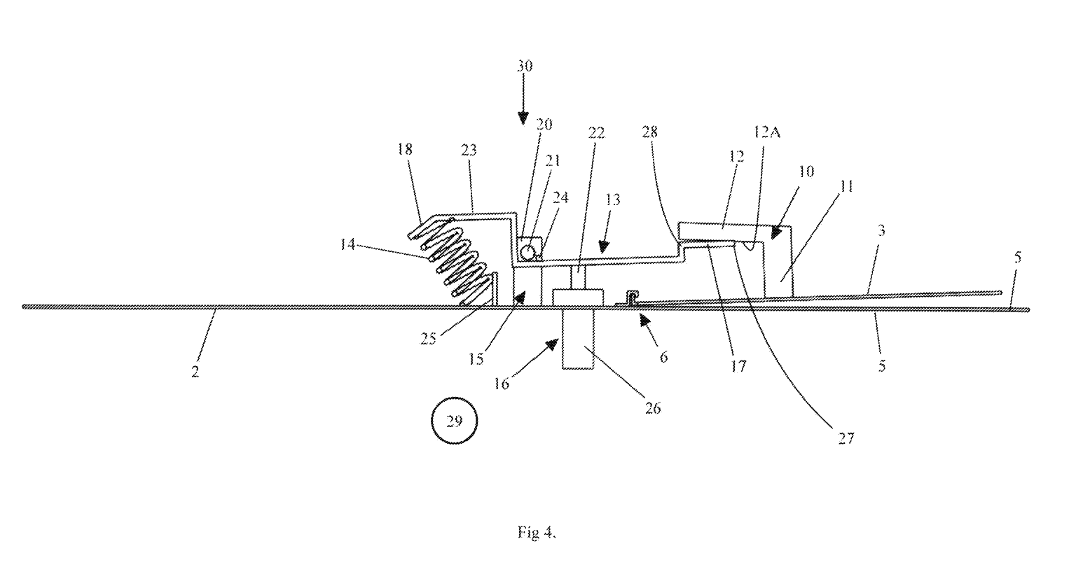

FIG. 4 shows, in the same section as FIG. 3, how the arrangement raised an opening part of the lid with a small gap,

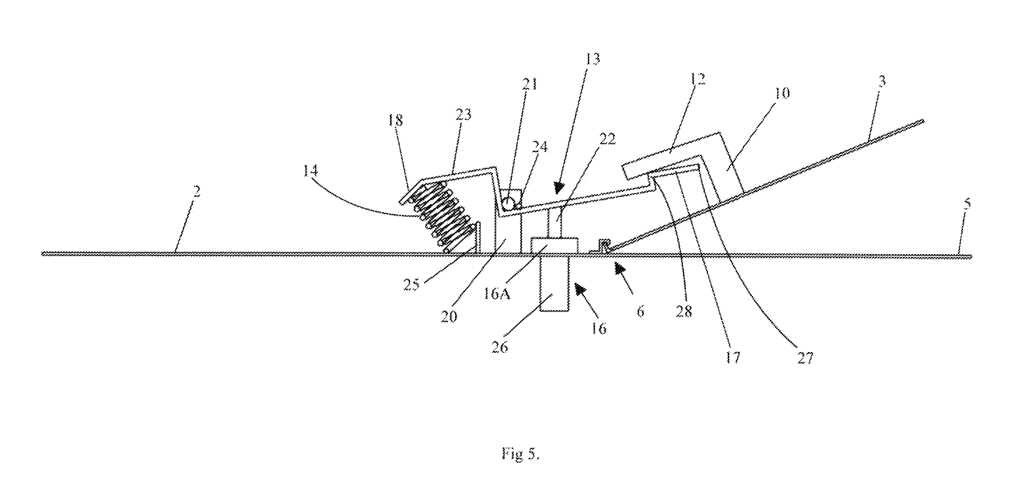

FIG. 5 shows, in the same section as FIGS. 3 and 4, how the arrangement raised the opening part of the lid to a relative position greater than the opening in FIG. 4,

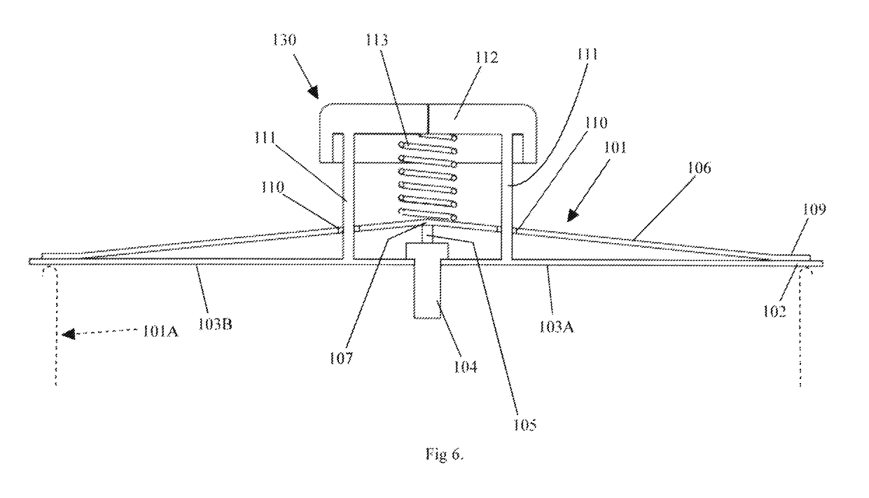

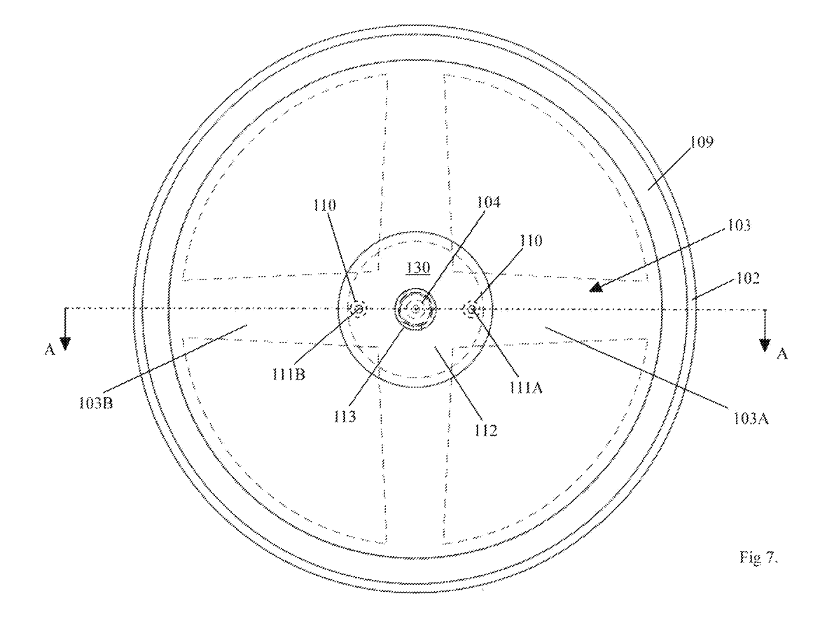

FIG. 6 schematically shows a sectional view of a stew pan with a second example of the arrangement in accordance with the invention viewed in a section A-A according to FIG. 7 in the closed position,

FIG. 7 shows the arrangement according to FIG. 6 from the top, as if it were lying on a cooking utensil, and

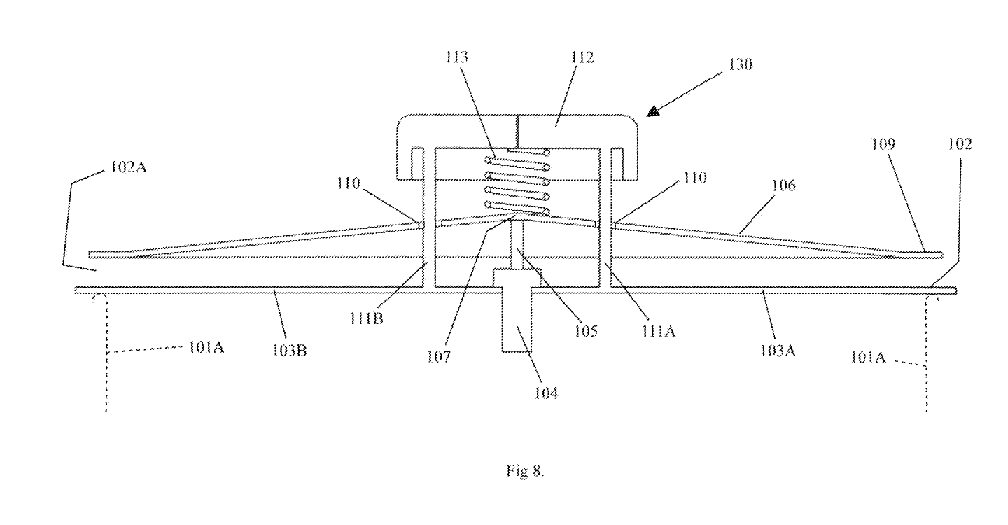

FIG. 8 shows the arrangement in section as in FIG. 6 but in an open position here.

As is apparent from the FIGS. 1-5 a first example of the arrangement in accordance with the invention comprises a round stew pan lid 1 with a main part 2 that is intended to rest against the edge at the opening of a cooking utensil 1A in the form of a stew pan (indicated with lines), and with an opening part 3 that geometrically forms a circular segment on the whole and covers an opening 4 in the main part 2 with an edge part 5. The edge part 5 extends concentrically outside the outer edge of the opening part 3 like a part in a circular arc segment with the same outer periphery as a part of the main part 2 and an inner periphery that is concentrically located inside the periphery of the opening part. The opening 4 in the main part 2 therefore has approximately the same segmental shape as the segment-shaped opening part 3 but is somewhat smaller and extends inside the entire edge of the opening part 3.

The opening part 3 is pivotably arranged on its segmental straight side on the main part 2 via a hinge part 6. The hinge part 6 consists of an extended guide hook 7 that is arranged along a middle part of the straight edge 8 of opening 4 and which guide hook is fastened upright in the figure on the main part 2 close to the segmental straight edge 8 of the opening 4, and of a lip 9 cooperating with the guide hook 7 which lip is fastened to the opening part 3. When the opening part 3 is raised, the opening part 3 is pivoting at the hinge part 6.

An opening mechanism 30 for a controlled opening of the opening part 3 is present on the top side of opening part 3 (seen in FIG. 1-5). A lifting hook 10 is part of opening mechanism 30 and has a form like an angle hook, fixed with a spacer part 11 that extends up mainly perpendicularly against the upper side of opening part 3. A lifting part 12 is part of lifting hook 10 and is perpendicular to the spacer part 11 and extends over the top side at the opening part 3 against the middle of the lid 1.

The lifting hook 10 cooperates with a lever 13 that has an upwardly bent, first step part 17 that rests against a lower lifting edge 12A of the lifting part 12 of the lifting hook 10, which lifting edge 12A is facing the opening part 3. The lever 13 consists of a stiff band which is bent into several steps along its extent and suitably consisting of metal like most of the opening mechanism 30. The lever 13 extends between and is held in place by a helical spring 14, a guide yoke 15 and a thermostat 16, from left to right in the figure, which can be of a known type and are described in detail below. The guide yoke 15 supports an intermediate part of the lever 13 from above and consists of two side supports 19 and 20 and a guide peg 21 fastened between them that rests against the top side of the lever 13. The guide peg 21 forms an axle around which the lever 13 can pivot under the action from on the one side the thermostat 16, that, when its temperature rises, tends to press the end of the lever 13, on the right in the figure, upwardly and on the other side of the helical spring 14, that tends to press the end of the lever 13 on the left in the figure upwardly around the guide peg 21 against the action of the thermostat 16. Thermostat 16 has a mounting flange 16A that rests against the top side of the lid 1. The function of the first step part 17 will be explained below.

The helical spring 14 is arranged between the main part 2 of the lid and a slightly obliquely bent first spring support part 18 for spring 14 on the lever 13. This will be explained in detail below. The thermostat 16 acts against the pressure of helical spring 14 via a piston 22 forming part of the thermostat, which piston rests, underneath, against the lever arm 13. In the position of use of the lid the weight of the opening part 3 coacts, to a certain extent, with the spring as the lifting hook 10 rests on the first step part 17 on the lever 13. In order to be held in place well, the lever 13 is provided with an upwardly bent second step part 23 between the guide peg 21 functioning as pivoting point and the spring-supported, obliquely bent support part 18, and a locking pin 24, which is fastened to the lever 13, a short distance from the second step part 23.

FIG. 2 shows that the helical spring 14 is compressed between the outer, first spring support part 18 of the lever 13 and a second spring support 25 at the main part 2 of the lid 1 so that the spring 14 is held in a well-defined position when it flexes in its working range, that is, is further compressed or expands. FIG. 2 also shows a sensor body 26 on the thermostat 16 at the bottom side of the lid 1 which sensor body 26 is designed to react to the steam temperature inside the stew pan 1A (schematically shown in FIG. 1 with lines) that the lid is intended to rest on.

FIG. 3 shows the invention example in a section from the same direction as in FIG. 2, which shows how the lever 13 is held in position with the guide peg 21 located between the second step part 23 and the locking pin 24. The spring 14 and the thermostat 16 are mounted in such a manner that they both, in combination with the guide yoke 15, tightly hold the lever 13 in a position where it is mainly parallel in its main extent with the top side of lid 1 when room temperature or in any case temperatures significantly below the boiling point of water prevail at the thermostat 16. The opening 4 in the lid 1 is therefore closed by opening part 2. The spring 14 is tensioned but in its least compressed position, and the piston 22 of the thermostat 16 is in a neutral position, that is, the thermostat 16 is not expanded.

FIG. 4 shows how the opening mechanism 30 caused the opening part 3 to lift off from the main part 2 in order to release excess energy, steam, through the opening 4 (not visible in this figure). This opening process takes place in the following manner. The sensor body 26 sensed that the temperature in the stew pan began to approach the boiling point (approximately 100° Celsius for water at normal air pressure). A wax body (not shown) in the sensor body then has begun to swell and therefore displaced piston 22 up. The piston 22 then lifts the part of lever 13 that the piston 22 rests against upwardly in a proportional manner. The first step part 17, that is formed with two end contact points, a toe part 27 and a heel part 28 (the first step part 17 can be conceived as a profile of a foot turned up and down) thereby, in contact with the lower edge 12A of the lifting hook 10, lifts it and the opening part 3 fastened to the lifting hook 10. The opening part 3 is coupled in a guiding manner to hinge part 6 and therefore the opening part 3 pivots according to the laws of mechanics around the hinge part 6 and lifts off from the edge part 5. In this manner a free passage is formed under the opening part 3 through the opening 4 (not shown in FIG. 4) between the inside 29 of the stew pan and the surrounding space, and energy in the form of steam in the stew pan is let out so that the temperature in the stew pan decreases, the temperature goes down and overcooking is counteracted. The spring 14 is pivoted at an angle and compressed during this course somewhat by the action of the lever 13. Since the spring 14 is mounted at an angle relative to the lid 1, standing against the oblique outer support 18 on the other step 23 of the lever, the spring is compressed with a lesser compression deflection relative to the movement of the thermostat at the beginning of its expansion, which is advantageous. If the opening that was produced is now sufficient, and the temperature changes in the stew pan act on the thermostat 16 in such a manner that its wax body stops swelling and the piston 22 is no longer pressed out, the opening mechanism 30 stops approximately in the position reached. A certain oscillating back and forth in the position can occur, since this is a regulating procedure. If the opening produced in accordance with the above-described course of action is insufficient and a temperature that is too high remains in the stew pan, and with it the danger of overcooking, the following further procedure takes place that is shown in FIG. 5. If the increase in temperature remains or is not sufficiently reduced by the opening achieved, the wax body in the thermostat 16 swells more and the force then becomes sufficient so that the thermostat's piston 22 will be able to compress the spring 14 further with the lever arm 13, i.e., lift the opening part 3 further with lever 13. The piston 22 of the thermostat 16 thus is pressed out somewhat further from the thermostat 13 in comparison to FIG. 4 and has lifted lever 13 so that the opening part 3 pivoted slightly further around the hinge part 6 and increased its upright angle relative to the main part 2 of the lid 1 in its position of use. Due to the fact that the distance between the hinge part 6 and the contact point between the lever arm 13, at the toe part 27 of the lever, (see FIG. 4) and the lower edge 12A of the lifting hook 10 is shorter than the distance between on the one hand the pivoting point of lever 13 around the guide peg 21 and on the other hand the toe part 27, the contact point between the lifting hook 10 and the lever 13 will shift from the toe part 27 to the heel part 28 on the lever arm (see FIG. 5). This has the effect that the regulated, pivoting action at the opening part 3 from the lever 13 increases since the effective lever length between the lifting hook 10 and the hinge part 6, acting with the opening part 2, becomes shorter. That is, for each degree that the lever step part 17 is now lifted, the opening part 3 is lifted higher than when the lever step part 17 contacted the lifting hook at the toe part 27. Therefore, this means that the lever length ratio at the opening mechanism 30 is altered and the regulation becomes optimised. In order to obtain the best possible controlled course of the opening of the lid 1 the helical spring 14 of the opening mechanism 30 is arranged, as previously cited, at an angle with the lid 1 and standing obliquely against the support part 18 on the lever 13, which is obliquely bent or angled, compared to the main extent of the lever 13. This brings about a changing in the lever length ratio of the pivoting of the lever 13 under the action of the expanding thermostat 16 which entails less work for the thermostat 16, i.e., the compression of the helical spring 14 becomes less than if it stood directly under the end part 18 of the lever, perpendicularly to the main plane of the lid 2. This makes it possible that the spring constant can be greater than otherwise, which brings about a reliable return of the thermostat 16 and therefore a closing of the opening part 3 in the last position when the temperature in the utensil decreases. This contributes to a lid lift that is finely regulated by the temperature and a holding open of the opening part 3, that is, a well-regulated opening function of the lid 1 is obtained. The main function of the spring, to press the piston 22 in, that is, to press together or return the thermostat 16 when the wax body shrinks with decreasing temperature, is therefore obtained by selecting the constants of the helical spring in relation to the geometrical conditions that were chosen for the parts of the opening mechanism 30 and the properties of the thermostat together with the described geometry.

FIGS. 6-8 show a second embodiment of an arrangement in accordance with the invention, in this case with an opening mechanism 130 of a somewhat simpler type than the example described above. Therefore, referring to the FIGS. 6-8, the arrangement according to the second example comprises a lid 101. The opening mechanism 130 comprises a base in the form of a plane ring 102 intended to rest against the edge of a cooking utensil 101A to be protected against overcooking. A cross-shaped centre part 103 is present integrated inside the ring conveniently in the same plane (see FIG. 7). The centre part 103 carries a thermostat 104 in its middle, basically of the same type as the thermostat in the first example, i.e., it has a piston 105 that shifts out when the temperature in the thermostat significantly rises. A coned upper lid 106 rests directly on the piston 105 of the thermostat 104, which upper lid also lies tightly against the ring 102 when the thermostat is not actuated. The coned upper lid 106 is rotationally symmetrical around its lid tip 107. In other words, the lid tip 107, or more precisely a cavity in the tip 107, rests in the position of use of the lid above the piston 105 of the thermostat and simultaneously the edge of the upper lid also has a circumferential contact with the ring 102. In order to achieve a more reliable contact, the edge of the upper lid is provided with a plane beveling 109. Two diametrically located holes 110 are present in the upper lid 106. Two pegs 111A and 111B extend through holes 110. The pegs 111A and 111B are each fastened at two spokes 103A and 103B of the cross shaped centre part 103, diametrically opposing one another in the centre part 103, close to its centre but outside of the part carrying the thermostat 104. A round knob is fastened to pegs 111A and 111 B outside of or rather above upper lid 106 viewed from the centre part 103. Finally, a helical spring 113 is compressed between the knob 112 and the upper lid 106 above the lid tip and in counteraction to the thermostat 104. The upper lid 106 thus is displaceably mounted between the helical spring 113 and the thermostat 104.

FIG. 8 shows how the thermostat 104 has reacted to a temperature close to the boiling point in the cooking utensil 101A and pressed the piston 105 out. The piston 105 then lifted the upper lid 106 and at the same time compressed the helical spring 113. The spring 113 is suitably formed in such a manner at its end standing against the upper lid 106 that the upper lid is balanced in such a manner that a slot-like, mainly annular opening 102A is formed around the upper lid 106, above the ring 102. In this position excess energy in the form of steam can be let out between the lid 101 and the ring 102.

When a sufficient amount of excess energy has been let out, the temperature is reduced and with it the force in the thermostat 104. The helical spring 113 is dimensioned in such a manner that it can press the upper lid 106 down and also piston 105 back into the thermostat 104 so that the escape of energy is regulated. A regulating course that is largely free of hysteresis is created in this connection.

The present invention is defined by the following claims and is not limited to what is described in conjunction with the exemplary embodiments shown in the drawings. For example, the hinge part in the example can consist of a so-called customary hinge iron, and the lid can have a different form; for example, it can be stamped so that it is not flat. The fastening method for the opening mechanism's details to the parts of the lid can be welding, adhering or another method known to the person skilled in the art. The spring can be another type than a helical spring, e.g., a resilient loop. The thermostat can be of a type that is customary in a cooling system for internal combustion engines in motorcars. In those, the actuator effect is achieved in that a medium, most frequently wax, undergoes a phase conversion upon an increase of temperature from solid to liquid, from liquid to gas or from solid to a gaseous form. The phase conversion results in an expansion of volume that for its part is used to exert a force on, e.g., a piston that is shifted in a cylinder. When the temperature drops, the course is reversed and in most types of this kind of thermostat an outside force is required to return the piston into the ‘neutral position”, in the example shown in the form of a helical spring. The regulating course for the escape opening that is important for the invention therefore takes place together with the spring power on the one hand and on the other hand with the force of the thermostat relative to the temperature, precisely as in the first example. The holes 110 in example 2 are of course dimensioned with a clearance for the pegs 111A and 111 B but with such a small slot that the escape of steam through the holes can be neglected in this connection. The size of the upper lid 106, that is, its diameter, can of course be varied and adapted to a corresponding degree to the diameter of the ring 102.

1. Arrangement for preventing overcooking in a combination of cooking utensils (1A, 101 A) with a lid (1, 101) when preparing food, characterized by an opening mechanism (30, 130), arranged at the lid (1, 101), for the regulated manoeuvring of an opening part (3, 106) on the lid (1, 101), which opening part cooperates with an opening (4, 102A) in the lid (1, 101) when temperatures close to the boiling point are reached in the cooking utensil, and which opening mechanism (30, 130) comprises a thermostat (16, 104) with a regulating piston (22, 105) and of the type that has a built-in expanding body acting on the piston (22, 105) and whose volume is a function of the temperature in the environment of the thermostat, whereby the thermostat is arranged, when temperatures approach the boiling point, to tend to cause the opening mechanism (30, 130) to guide the opening part (3, 106) into an open position in a regulated manner by the regulating piston (22, 105), and comprises a spring (14, 113) that is arranged to tend, working against the thermostat (16, 104), to bias the opening mechanism (30, 130) and the opening part (3, 106) to a closed position at the opening (4, 102A) when the temperature decreases.

2. The arrangement according to claim 1, characterized by the fact that the opening mechanism (30) comprises a lever (13) fastened in an articulated manner for opening the opening part (3)and that the lever (13) is arranged so as to cooperate with the thermostat (16) and the spring (14) for the regulated opening of the opening part (3).

3. The arrangement according to claim 2, characterized by the fact that the lever is arranged to cooperate with a lifting hook (10) on the opening part (3) and comprises a first step part (17) with two end contact points (27, 28) arranged to alternately cooperate with the lifting hook (10) when there are different degrees of opening of the opening mechanism (30).

4. The arrangement according to claim 1, characterized by the fact that the thermostat (104) operates mechanically directly against the spring (113) with the opening part (106) displaceably mounted between the thermostat (104) and the spring (113).
